(19) United States
(12) Patent Application Publication
(10) Pub. No.: US 2008/0098298 A1
(43) Pub. Date: Apr. 24, 2008

(54) Compound Web Document Generation Method and Web-based Editing System for Generating a Compound Web Document

(76) Inventors: Chao-Chun Lee, Taipei (TW); Chun-Nan Yu, Taipei (TW); Hao-Wei Cheng, Taipei (TW); Wen-Hao Hsu, Taipei (TW)

Correspondence Address: NORTH AMERICA INTELLECTUAL PROPERTY CORPORATION, P.O. BOX 506, MERRIFIELD, VA, 22116, US

(21) Appl. No.: 11/962,115

(22) Filed: Dec. 21, 2007

Related U.S. Application Data
(63) Continuation-in-part of application No. 10/989,375, filed on Nov. 17, 2004.

(51) Int. Cl. G06F 3/14

(52) U.S. Cl. 715/234

(57) ABSTRACT

Files of various file formats are converted into markup language files, such as HTML files or XML-based files, and a compound web document is generated from the markup language files so that the compound web document may be displayed using a web browser, such as Internet Explorer. Files of the above-mentioned file formats may include a PowerPoint file (*.ppt), a Word file (*.doc), an Excel file (*.xls), a single packaged web page (*.mht), and an image file (*.bmp, *.jpg, *.gif, *.png). Thus the compound web document may be retrieved without linking any other files.

### CROSS REFERENCE TO RELATED APPLICATIONS

This application is a continuation-in-part of prior application Ser. No. 10/989,375, filed Nov. 17, 2004, and entitled “Web-based Editing System of Compound Documents and Method thereof”, the contents of which are incorporated herein by reference.

### BACKGROUND OF THE INVENTION

1. Field of the Invention

The present invention relates to a compound web document generation method and a web-base editing system for generating a compound web document, and more particularly, to a compound web document generation method based on a plurality of file formats and a web-base editing system for supporting the compound web document generation method.

2. Description of the Prior Art

Conventionally, contents of files of various file formats may be directly viewed in the form of a web document. In the web document browsed by a web browser, contents of various types of file formats from various application programs are integrated in a computer system, where files of file formats in the web document may include text files (*.txt, *.rtf, *.wri), Excel files (*.xls), Access files (*.mdb), Word files (*.doc), PowerPoint files (*.ppt), Adobe portable document format files (*.pdf), web pages (*.htm), email files (*.eml), uniform resource locators (*.url), active server pages (*.asp), and general images (*.jpg, *.gif, *.bmp). Furthermore, files of the abovementioned file formats may be displayed or browsed by calling for related application programs with a web browser.

However, the called application programs, such as Microsoft Word, Microsoft Excel, and Microsoft PowerPoint, have to be installed on a local terminal, such as a local computer or a client terminal, in advance to be called for. Moreover, a user of the local terminal is generally inexperienced in integrating files of various file formats since he may merely include the files with links. For example, while mere links are used for including files, such as an Excel file or a PowerPoint file, an Excel sheet cannot be easily combined with a PowerPoint slide to generate a new web document, sheets of the Excel file and slides of the PowerPoint file included in which cannot be viewed page by page since mere links are included in the new web document. Therefore, generating and browsing such a web document is time-consuming and inconvenient to common users.

### SUMMARY OF THE INVENTION

The claimed invention discloses a compound web document generation method. The method comprises uploading a plurality of files, converting the uploaded files into markup language files, saving the markup language files in a file register, and generating a compound web document from the markup language files stored in the file register.

The claimed invention further discloses a web-based editing system for generating a compound web document. The system comprises a client terminal, a server terminal, and a tunnel. The client terminal comprises a document database, a web browser, and a user interface. The document database is utilized for storing files of various file formats. The server terminal comprises a file-uploading module, a file-converting module, and a file register. The file-uploading module is utilized for uploading stored files of the document database from the client terminal. The file-converting module is utilized for converting uploaded files of the file-uploading module into markup language files. The file register is utilized for saving the uploaded files of the file-uploading module, the markup language files of the file-converting module, and a compound web document. The tunnel is utilized for implementing communication between the client terminal and the server terminal. The web browser is utilized for displaying the compound web document. The user interface is utilized for manipulating operations of the web browser, the file-uploading module, the file-converting module, and the file register. The compound web document is generated from manipulations of the user interface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram for illustrating a web-based editing system according to a preferred embodiment of the present invention.

FIG. 2 illustrates a web-based editing method according to a preferred embodiment of the present invention.

FIG. 3 illustrates a diagram of a user interface utilized in the web-based editing system shown in FIG. 1 according to a preferred embodiment of the present invention.

FIG. 4 illustrates a document-uploading function displayed on the user interface shown in FIG. 3 according to a preferred embodiment of the present invention.

FIG. 5 illustrates a document-previewing function displayed the user interface shown in FIG. 3 according to a preferred embodiment of the present invention.

FIG. 6 illustrates a document-editing function displayed on the user interface shown in FIG. 3 according to a preferred embodiment of the present invention.

FIG. 7 illustrates an electronic white-boarding module integrated with and displayed on the user interface shown in FIG. 3 according to a preferred embodiment of the present invention.

### DETAILED DESCRIPTION

Some appropriate and preferred embodiments of the present invention will now be described in the following. It should be noted, however, that the embodiment is merely an example and can be variously modified without departing from the range of the present invention.

For relieving the defects discussed in the prior art, the present invention discloses a compound document generation method and a web-based editing system for supporting the compound web document generation method. With the aid of the compound web document generation method and the web-based editing system, contents of different file formats may be integrated into a compound web document based on markup language files, such as an HTML file or an XML-based file. Files of the different file formats may include a PowerPoint file (*.ppt), a Word file (*.doc), an Excel file (*.xls), a single packaged web page (*.mht), and an image file (*.bmp, *.jpg, *.gif and *.png).

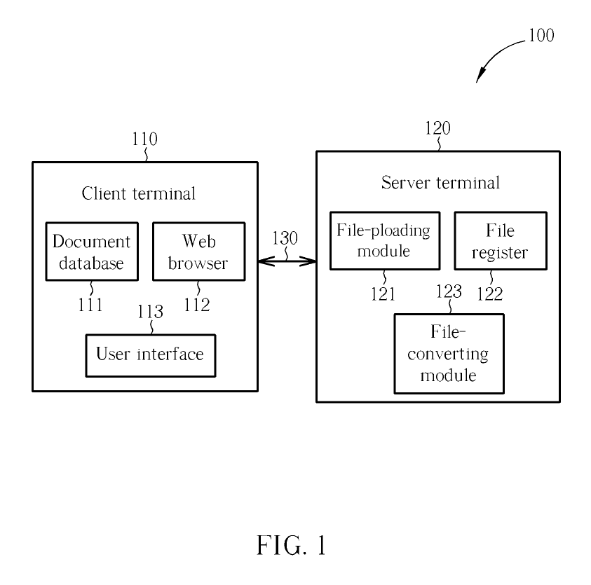

FIG. 1 is a diagram for illustrating a web-based editing system 100 according to a preferred embodiment of the present invention. As shown in FIG. 1, the web-based editing system 100 includes a client terminal 110, a server terminal 120, and a tunnel 130 for connecting the client terminal 110 and the server terminal 120. The client terminal 110 includes a document database 111, a web browser 112, and a user interface 113. The document database 111 stores files of various file formats. The server terminal 120 includes a file-uploading module 121, a file-converting module 122, and a file register 123. A tunnel 130 is utilized for implementing communications between the client terminal 110 and the server terminal 120, and is implemented according to Request for Comments (RFC) 1867, which discloses specifications of uploading form-base files in HTML. The file-uploading module 121 uploads a plurality of files stored in the document database 111 from the client terminal 110 to the server terminal 120 through the tunnel 130. The file-converting module 122 converts uploaded files of the file-uploading module 121 into markup language files. The file register 123 saves uploaded files of the file-uploading module 121, the markup language files of the file-converting module 122, and a compound web document. The web browser 112 is utilized for displaying the compound web document. The user interface 113 is utilized for manipulating operations of the web browser 112, the file-uploading module 121, the file-converting module 122, and the file register 123. The compound web document is generated with manipulations of the user interface 113 issued by a user of said user interface 113.

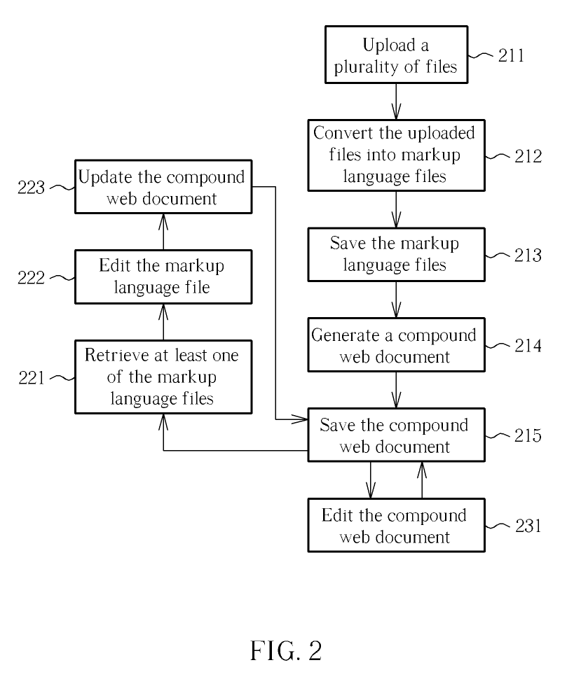

FIG. 2 illustrate a compound web document generation method according to a preferred embodiment of the present invention. As shown in FIG. 2, the compound web documents generation method includes steps as follows:

Step 211: Upload a plurality of files from a document database to a server terminal by a file-uploading module;

Step 212: Convert the uploaded files into markup language files by a file-converting module;

Step 213: Save the markup language files in a file register;

Step 214: Generate a compound web document from the markup language files stored in the file register;

Step 215: Save the compound web document in the file register;

Step 221: Retrieve at least one of the markup language files stored in the file register;

Step 222: Edit the retrieved markup language file;

Step 223: Update the compound web document according to the edited markup language file; and

Step 231: Edit the compound web document.

In embodiments of the present invention, combinations and permutations based on the steps shown in FIG. 2 are not limited to as shown in FIG. 2. For example, the compound document saved in Step 215 may not be edited, in such case, Step 221, Step 222, Step 223, and Step 231 may be skipped.

Please refer to FIG. 1 and FIG. 2 together. In Step 211, the file-uploading module 211 uploads required files from the document database 111 to the server terminal 120 according to instructions from the user interface 113, where the instructions are issued by a user of the user interface 113. Note that files stored in the document database 111 may include PowerPoint files (*.ppt), Word files (*.doc), Excel files (*.xls), single packaged web pages (*.mht), or image files (*.bmp, *.jpg, *.gif and *.png). In Step 212, the file-converting module 122 converts the uploaded files into markup language files, which may be HyperText Markup Language (HTML) files or eXtensible Markup Language (XML) files. Note that the file-converting module 122 may be implemented according to Component Object Model (COM) of Microsoft Office (via Java Native Interface on J2EE platform). In Step 213, the markup language files are temporarily saved in the file register 113 for additional usage. In Step 214, a compound web document is generated from the markup language files stored in the file register 123 so that the compound web document may integrate file formats of the files stored in the document database 111. Note that the compound web document may be generated according to various combinations and permutations of the markup language files. In Step 215, the compound web document is temporarily saved into the file register 123, where said compound web document may be further edited.

The user interface 113 provides functions of editing the compound web document, where editing the compound web document includes editing at least one markup language file for generating the compound web document or editing the compound document itself. In Step 221, the markup language file is retrieved from the file register 123, and is directly edited in Step 222. Therefore, in Step 223, the compound web document having the edited markup language file is updated according to said markup language file. At last, the edited compound web document, which has the edited markup language file, is saved back to the file register 123 in Step 215 in a recursive manner. When the compound web document itself is to be edited, in Step 231, the compound web document is retrieved from the file register 123. After the compound web document is edited, said compound web document is saved back in Step 215 in a recursive manner.

At last, while the user intends to browse a required compound web document, said required compound web document is retrieved from the file register 123, and is then displayed or browsed with the aid of the web browser 112.

Note that in Step 213, the compound web document may be generated for meeting requirements of viewing a certain sheet of a Excel file or opening a certain slide of a PowerPoint file, where both the Excel file and the PowerPoint file are uploaded from the document database 111 and stored in the file register 123.

In practice, the compound web document generation method may be implemented and supported by the web-base editing system 100, as described in the following example. In the example, a PowerPoint file (*.ppt) may be loaded by the file loading module 121, is converted into an HTML file using the file-converting module 122, where the HTML file is then stored in the file register 123 in Step 213. Note that the file-converting module 122 may be implemented according to the COM components in the Microsoft Office. Therefore, a compound web document related to the HTML file is generated in Step 214, and is saved in the file register 123 in Step 215. For example, the compound web document may integrate files of various file formats, such as *.html, *.jpg, *.gif, and *.xml. Then in Step 221 and Step 222, required information of each slide of the PowerPoint file, which is saved in the file register 123 in Step 215, is retrieved and edited according to instructions issued from the user interface and by the user. The compound web document having the PowerPoint file is then updated in Step 223, and is saved back to the file register 123 in Step 215. Note that the information of each the slide may be a heading of each said slide. Therefore, in Step 215 again, the edited information of each the slide is saved along with related URL paths in the compound document, which may be saved as an XML file at this time. Note that files of file formats other than the PowerPoint file may also be integrated into the saved XML file in Step 215. In this regard, the XML file acquires all URL paths and descriptions related to the PowerPoint file, such as a file name, or headings of the PowerPoint file. Moreover, while the XML file is retrieved or loaded through the user interface 113, the web-based editing system 100 is capable of performing functions of the edited information and the integrated files of other file formats while browsing the compound web document, such as adjusting a slide order applied by the PowerPoint file, modifying the headings of all the slides of the PowerPoint file, hiding the PowerPoint file, and displaying the PowerPoint file page by page.

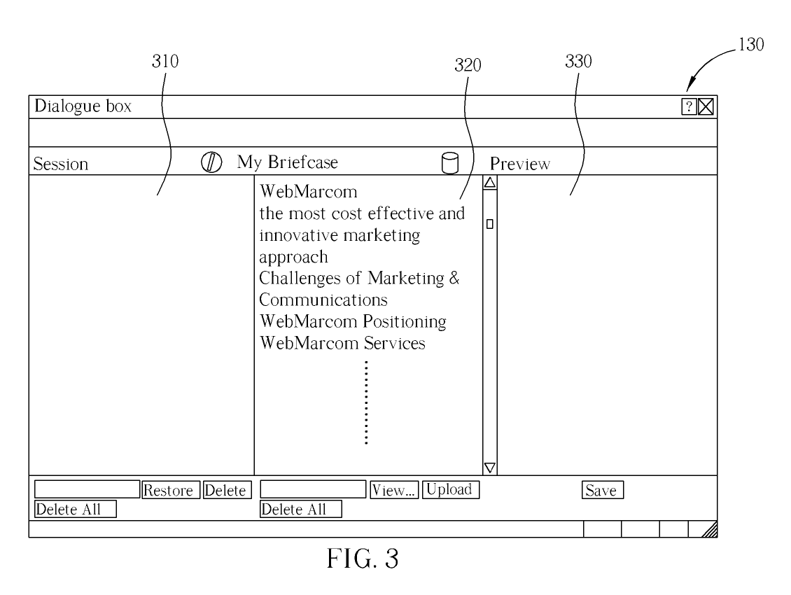

For further describing the web-based editing system in FIG. 1 and the compound document generation method in FIG. 2 in detail, FIG. 3 illustrates a diagram of the user interface 113 utilized in the web-based editing system 100 shown in FIG. 1 according to a preferred embodiment of the present invention. As described before, operations of the user interface 113 are fully supported by units of the web-based editing system 100 shown in FIG. 1 and the compound web document method in FIG. 2. As shown in FIG. 3, the user interface 113 displays a document editing area 310, a personal web folder area 320, and a preview area 330. The document editing area 310 is configured to edit the compound web document or a markup language file, and denoted with a title “Session” in FIG. 3. The personal web folder area 320 is configured to display the compound web document, and is denoted with a title “My Briefcase” in FIG. 3. The preview area 330 is configured to preview an edited compound web document or the edited markup language file, and is denoted with a title “Preview” in FIG. 3.

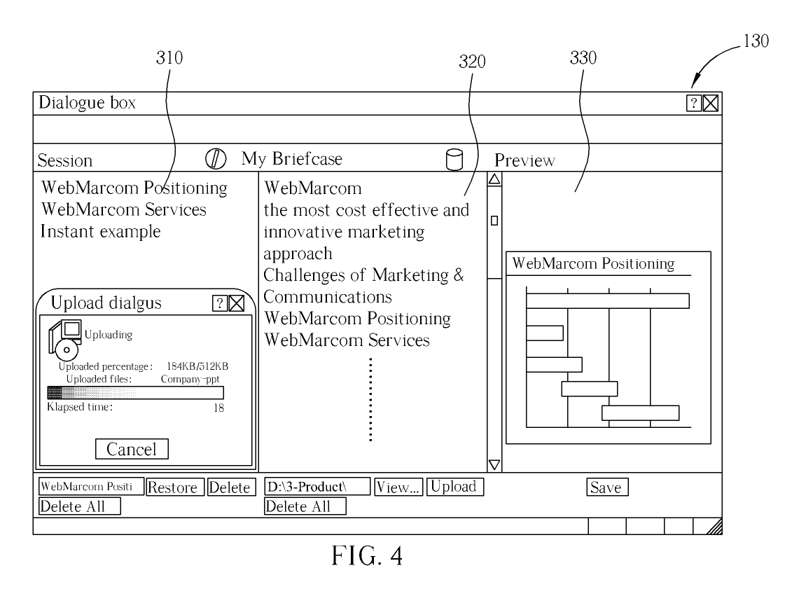

FIG. 4 illustrates a document-uploading function displayed on the user interface 113 shown in FIG. 3 according to a preferred embodiment of the present invention. While Step 211 shown in FIG. 2 is to be performed, a dialogue box for uploading required documents may be displayed on the user interface 113. As described before, the document-uploading function may be implemented with the tunnel 130, which may be implemented with a wireless tunnel by using Request for Comments (RFC) 1867, which discloses specifications of uploading form-based files in HTML.

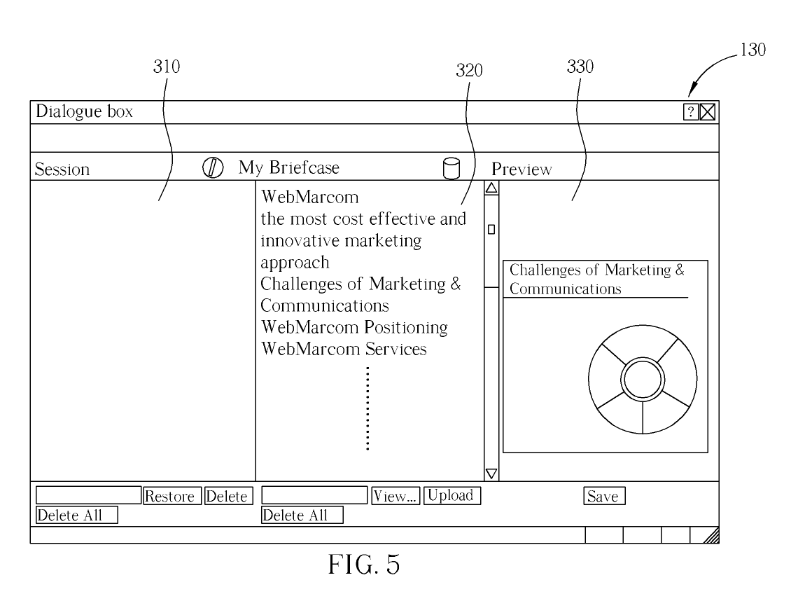

FIG. 5 illustrates a document-previewing function displayed the user interface 113 shown in FIG. 3 according to a preferred embodiment of the present invention. A user of the editing system 100 may preview a edited HTML file or an edited compound web document, on the user interface 113 by using the web browser 112, which may be implemented with Internet Explorer.

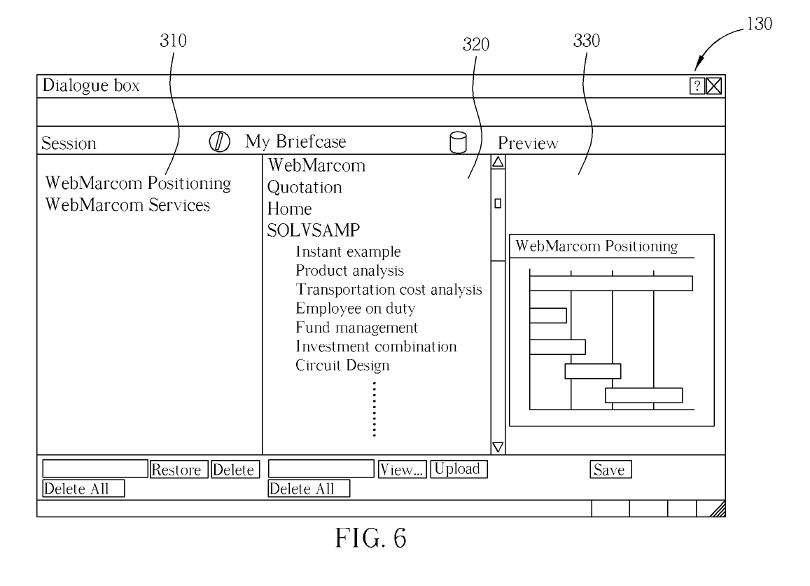

FIG. 6 illustrates a document-editing function displayed on the user interface 113 shown in FIG. 3 according to a preferred embodiment of the present invention. The user interface 113 may be installed with a display function for displaying the compound document page by page using a web browser. For instance, a PowerPoint file illustrated in FIG. 6 is divided into several slides having titles including “Product analysis”, “Transportation cost analysis”, “Employee on duty”, “Fund management”, “Investment combination”, and “Circuit design”. Note that the listed titles of the slides along with related URL paths may be written into a compound web document in the form of a XML file for saving the descriptions of the uploaded documents. At last, the XML file along with related information, such as the URL paths related to the divided slides, are compressed as a single packaged file by using a compression mechanism, which may be implemented with compression programs for compressing a bunch of files into a compressed file having a file format *.zip. The single packaged file, which may be a compressed file, may be downloaded or browsed through manipulations on the user interface 113 so as to run functions, such as adjusting a slide order of the PowerPoint file on the compound web document, modifying headings of slides of the PowerPoint file on the compound web document, hiding the PowerPoint file on the compound web document, and previewing the PowerPoint file on the compound web document.

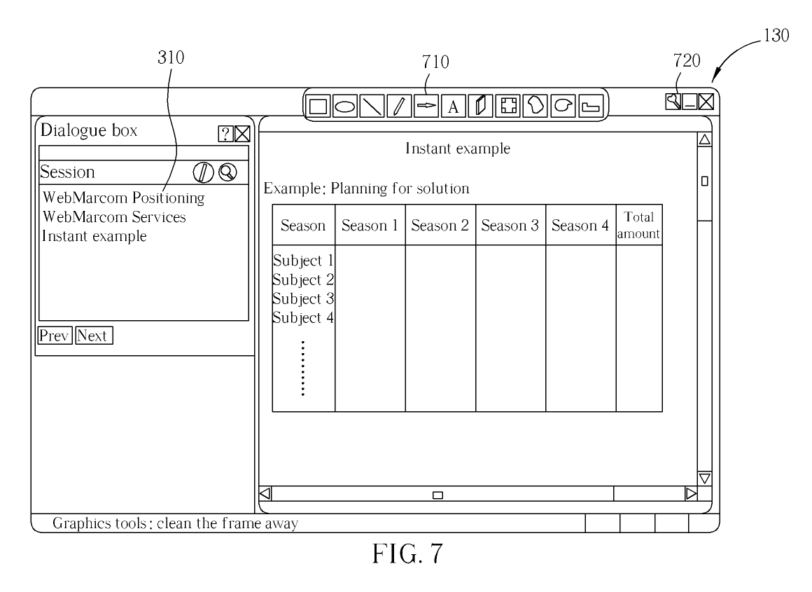

FIG. 7 illustrates an electronic white-boarding module integrated with and displayed on the user interface 113 shown in FIG. 3 according to a preferred embodiment of the present invention. For displaying the electronic white-boarding module on the user interface 113, both the personal web folder area 320 and the preview area 330 are replaced, and instead, both an assistant menu bar 710 and an additional menu bar 720 of the electronic white-boarding module are displayed on the user interface 113. While files of various file formats are integrated into a HTML file and even into a compound document generated from the HTML file, additional functions, which are previously not able to be performed, may be performed with the aid of the electronic white-boarding module. It should be appreciated that the electronic white-boarding module is not an emphasis of the present invention and is well known by those who skilled in the art, therefore, related descriptions are not described herein for brevity.

The present invention discloses a compound web document generation method and a web-based editing system for facilitating browsing web-based files in the form of a compound web document. With the aid of the disclosed web-base editing system and compound web document generation method, the compound web document is more easily generated, edited, and browsed than the web document in the prior art since links are no longer required in the compound web document, and instead, files of various file formats are all converted into markup language files. Therefore, the defect of time-consuming properties and inconveniences in the prior art is relieved by the easily generated, edited, and browsed compound web document.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A compound web document generation method comprising:
uploading a plurality of files;
converting the uploaded files into markup language files;
saving the markup language files in a file register; and
generating a compound web document from the markup language files stored in the file register.

2. The method of claim 1 further comprising saving the compound web document.

3. The method of claim 1 wherein generating the compound web document is generating a single packaged document.

4. The method of claim 3 wherein generating the single packaged document is generating an XML-based packaged document.

5. The method of claim 1 further comprising displaying the compound web document using a web browser.

6. The method of claim 1 further comprising:
retrieving at least one of the markup language files stored in the file register;
editing the retrieved markup language file; and
updating the compound web document according to the edited markup language file.

7. The method of claim 1 further comprising editing the compound web document.

8. The method of claim 1 further comprising:
providing a user interface having a document editing area, a personal web folder area, and a preview area;
wherein the document editing area is configured to edit the compound web document or a retrieved markup language file; the personal web folder area is configured to display the compound web document; and the preview area is configured to preview an edited compound web document or the edited markup language file.

9. The method of claim 1 wherein converting the uploaded files into markup language files comprises converting the uploaded files into HyperText Markup Language (HTML) files.

10. The method of claim 1 wherein converting the uploaded files into markup language files comprises converting the uploaded files into eXtensible Markup Language (XML) files.

11. The method of claim 8 wherein the compound web document is displayed on the preview area using the web browser.

12. The method of claim 1 wherein uploading the plurality of files is uploading a plurality of files including a PowerPoint file (*.ppt), Word file (*.doc), Excel file (*.xls), single packaged web page (*.mht), or image file (*.bmp, *.jpg, *.gif and *.png).

13. The method of claim 6 wherein editing the retrieved markup language file comprises:
adjusting a sequence of slides of the retrieved markup language file;
modifying headings of the slides of the retrieved markup language file; or
hiding the retrieved markup language file.

14. The method of claim 7 wherein editing the compound web document comprises:
adjusting a sequence of slides of the compound web document;
modifying headings of the slides of the compound web document;
hiding the compound web document; or
displaying the compound web document page by page.

15. A web-based editing system for generating a compound web document comprising:
a client terminal comprising:
a document database for storing files of various file formats;
a web browser; and
a user interface;
a server terminal comprising:
a file-uploading module for uploading stored files of the document database from the client terminal;
a file-converting module for converting uploaded files of the file-uploading module into markup language files; and
a file register for saving the uploaded files of the file-uploading module, the markup language files of the file-converting module, and a compound web document; and
a tunnel for implementing communication between the client terminal and the server terminal;
wherein the web browser is utilized for displaying the compound web document;
wherein the user interface is utilized for manipulating operations of the web browser, the file-uploading module, the file-converting module, and the file register;
wherein the compound web document is generated from manipulations of the user interface.

16. The web-based editing system of claim 15 wherein the user interface has a document editing area, a personal web folder area, and a preview area; the document editing area is configured to edit the compound web document or the markup language files; the personal web folder area is configured to display a compound web document attached by a user of the user interface; the preview area is configured to preview the edited compound web document or the edited markup language files using the web browser.

17. The web-based editing system of claim 15 wherein the markup languages are HyperText Markup Language (HTML) or eXtensible Markup Language (XML).

18. The web-based editing system of claim 15 wherein the files stored in the document database comprise a PowerPoint file (*.ppt), a Word file (*.doc), an Excel file (*.xls), a single packaged web page (*.mht), or an image file (*.bmp, *.jpg, *.gif and *.png).

19. The web-based editing system of claim 15 wherein the tunnel is implemented as a wireless tunnel according to Request for Comments (RFC) 1867.

20. The web-based editing system of claim 15, wherein the file-converting module is implemented according to Component Object Model (COM) of Microsoft Office (via Java Native Interface on J2EE platform).

21. The web-based editing system of claim 15 wherein functions of the document editing area include adjusting a sequence of slides of the compound web document, modifying the headings of the slides of the compound web document, hiding the compound web document, and displaying the compound web document page by page.
